(19) United States
(12) Patent Application Publication
(10) Pub. No.: US 2003/0021261 A1
(43) Pub. Date: Jan. 30, 2003

(54) Internet telephony gateway system

(75) Inventors: Jeong Jun Ahn, Seoul (KR); Tae Ik Kang, Anyang-shi (KR)

Correspondence Address: Jonathan Y. Kang, Esq., Lee & Hong P.C., 11th Floor, 221 N. Figueroa Street, Los Angeles, CA, 90012-2601, US

(73) Assignee: LG Electronics Inc.

(21) Appl. No.: 09/968,082

(22) Filed: Oct. 1, 2001

(30) Foreign Application Priority Data
Jul. 24, 2001 (KR) 2001-44636

(51) Int. Cl. H04L 12/66

(52) U.S. Cl. 370/352; 370/466

(57) ABSTRACT

An Internet telephony gateway system includes a main controlling device that prepares a packet comprising compressed voice data and transmits the packet to the communication network, or extracts compressed voice data from the packet received from the communication network and transmits the extracted data to at least one specific function board in response to a signal form of the extracted data. The system also includes at least one specific function device connected to the main controlling device for processing one of analog signal protocol and digital signal protocol. The extracted data is provided to a digital specific function device to communicate with a communication device capable of processing digital data, and the extracted data is provided to an analog specific function device to communicate with a communication device capable of processing analog data.

### CROSS REFERENCE TO RELATED ART

This application claims the benefit of Korean Patent Application No. 2001-44636, filed on Jul. 24, 2001, which is hereby incorporated by reference.

### BACKGROUND OF THE INVENTION

1. Field of the Invention

The present invention relates to an Internet telephony gateway system, and more particularly, to an Internet telephony gateway designed in a small capacity box type form, in consideration with a testing ability and a system expansion, to enable the use of a mounting type or a stand-alone type rack.

2. Description of the Related Art

Generally, an Internet phone means interactive voice conversation between personal computer (PC) operators through an Internet Protocol (IP) network in real time. Demand of the Internet phone is on an increasing trend owing to its inexpensive communication fees. The Internet phone is divided into a PC-to-PC type, a PC-to-phone type, and a phone-to-phone type depending on communication means.

Presently, various examples of the PC-to-PC type and the PC-to-phone type have been developed. The PC-to-PC type transmits and receives voice data through a mike and a speaker by connecting corresponding PCs with each other. The PC-to-PC type is implemented in such a manner that both PCs access to an IP network at the same time. Analog voice signals received through the mike using one program are digitized between the PCs, and the digitized data are compressed to obtain packet data.

When the packet type voice data are transmitted to an opposing PC through the IP network, a corresponding PC restores the packet type voice data and outputs an original voice through the speaker. The PC-to-PC type that enables communication as above has a problem in that both PCs must have access to the IP network at the same time using one program.

The PC-to-phone type is implemented in such a manner that after a predetermined program is installed in a corresponding PC, both PC and phone have access to the Internet and then linked to a public switched telephone network (PSTN) through an Internet telephony gateway installed in a specific area. Accordingly, the PC-to-phone type enables communication using a phone. However, the PC-to-phone type has a problem in that any one of the PC and the phone should be linked to the PSTN.

A related art Internet telephony gateway and a schematic network for Internet communication services will be described with reference to FIG. 1. As shown in FIG. 1, a corresponding Internet telephony gateway system is linked to either a PSTN or an IP network. Subscribers of either the PSTN or the IP network can perform communication through the IP network using terminal units, such as telephones and computers.

However, the Internet telephony gateway system of the related art has the following disadvantages. In an analog type, FXS, FXO, and E&M functions are fixed to a two (2)-channel unit, a four (4)-channel unit, or an eight (8)-channel unit, and in a digital type, the system type is fixed to support a T1/E1 connection. Therefore, change of system type is difficult, system upgrade is limited, and individual testing and maintenance of each module in the system is difficult, thereby resulting in a limited use of the system. In addition, the analog type cannot be used with the digital type causing an inconvenience of having to form two (2) separate systems.

### SUMMARY OF THE INVENTION

Accordingly, the present invention is directed to an Internet telephony gateway system that substantially obviates one or more problems due to limitations and disadvantages of the related art.

An object of the present invention is to provide an Internet telephony gateway system in which an external connector is divided into a public telephone connector and an IP connector, the IP connector including a function module of a main controlling board to control an entire system, and the public telephone connector being divided into analog/digital types according to supporting types to form a specific function board having a voice compressing/restoring module as a sub module, thereby facilitating individual test and maintenance.

Another object of the present invention is to provide an Internet telephony gateway system in which a main control connector is formed in a specific function board and a specific function connector is formed in a main controlling board by unifying interfacing methods of the specific function board and the main controlling board to enable the specific function board and the main controlling board to be detached from a plurality of slots, thereby facilitating a structure of the system and increasing its capacity.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a gateway system for use with a communication network to communicate between a first communication device and a second communication device, comprises a main controlling device that controls the gateway system which links the first and the second communication devices, the main controlling device preparing a packet comprising compressed voice data and transmitting the packet to the communication network or extracting compressed voice data from the packet received from the communication network and transmitting the extracted data to at least one specific function board in response to a signal form of the extracted data; and at least one specific function device connected to the main controlling device for processing one of analog signal protocol and digital signal protocol, wherein the extracted data is provided to a digital specific function device to communicate with a communication device capable of processing digital data, and the extracted data is provided to an analog specific function device to communicate with a communication device capable of processing analog data.

According to one aspect of the present invention, the main controlling device includes a processor module executing an operational program that supports interface with the specific function device; and a PCM switching unit establishing paths of PCM buses of the processor module and voice compressing/restoring processors.

According to another aspect of the present invention, the analog specific function device includes a voice compressing/restoring processor for compressing, using a predefined compression algorithm, a voice data received from the PCM switching unit and transmitting the compressed data to the main controlling device, and for restoring compressed voice data received from the main controlling device and transmitting the restored voice data to a corresponding PCM switching unit; a control logic unit that provides information pertaining to a mounting status of specific function device and interfacing with the PCM switching unit and the voice compressing/restoring processor; a sub module adapter for receiving at least one sub module and for transmitting connection status to the control logic unit; a ring producing unit connected to the sub module adapter for producing a call signal to the sub module adapter; and a codec unit for converting a predetermined protocol signal received from the sub module adapter to PCM data or converting the PCM data received from the PCM switching unit of the main controlling device to the predetermined protocol.

According to another aspect of the present invention, the predetermined protocol signal is one of an A-law or μ-law signal.

According to another aspect of the present invention, the analog specific function device includes an analog connector supporting a physical connection with a telephone, facsimile unit, or other compatible device in accordance with the sub module connected to the sub module adapter capable of handling such devices.

According to another aspect of the present invention, the digital specific function device includes a voice compressing/restoring processor for compressing, using a predefined compression algorithm, a voice data received from the PCM switching unit and transmitting the compressed data to the main controlling device, and for restoring compressed voice data received from the main controlling device and transmitting the restored voice data to a corresponding PCM switching unit; a digital frame converter for converting a first digital type signal to a PCM data and converting a PCM data received by the PCM switching unit to a first digital type signal; and a control logic unit that provides status of the digital specific function device.

According to another aspect of the present invention, the first digital type signal is preferably an E1/T1 signal or other fast transmission signal known to one of ordinary skill in the art. Preferably, the control logic unit further produces a signal for initializing the digital frame converter and forming an interface matching logic between a PCM bus linked to the PCM switching unit of the main controlling device and the digital frame converter.

According to another aspect of the present invention, the gateway system further includes a power processor divided into an AC/DC unit and a DC/DC unit; and a back board for supporting a communication interface between the main controlling device and the specific function device using a plurality of adapters to enable each board to be mounted inside the system. The back board is formed so that a position of the main controlling device is designated to a specific adapter and that the remaining adapters are randomly mounted with the specific function devices.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention. In the drawings:

FIG. 1 illustrates the Internet telephony gateway system according to the related art;

FIG. 2 illustrates the Internet telephony gateway system according to a preferred embodiment of the present invention;

FIG. 3 illustrates a schematic block diagram of the main board according to the preferred embodiment of the present invention;

FIG. 4 illustrates a schematic block diagram of an analog support board according to the preferred embodiment of the present invention;

FIG. 5 illustrates a schematic block diagram of a digital support board;

FIG. 6 illustrates a preferred embodiment of the case structure for supporting the Internet telephony gateway system according to the present invention;

FIGS. 7A to 7C illustrate portions of specific function boards of the present invention divided according to each functional characteristic;

FIG. 8 illustrates the structure of a system mounting type and a service network for an analog protocol; and

FIG. 9 illustrates the structure of a system mounting type and a service network for a digital protocol.

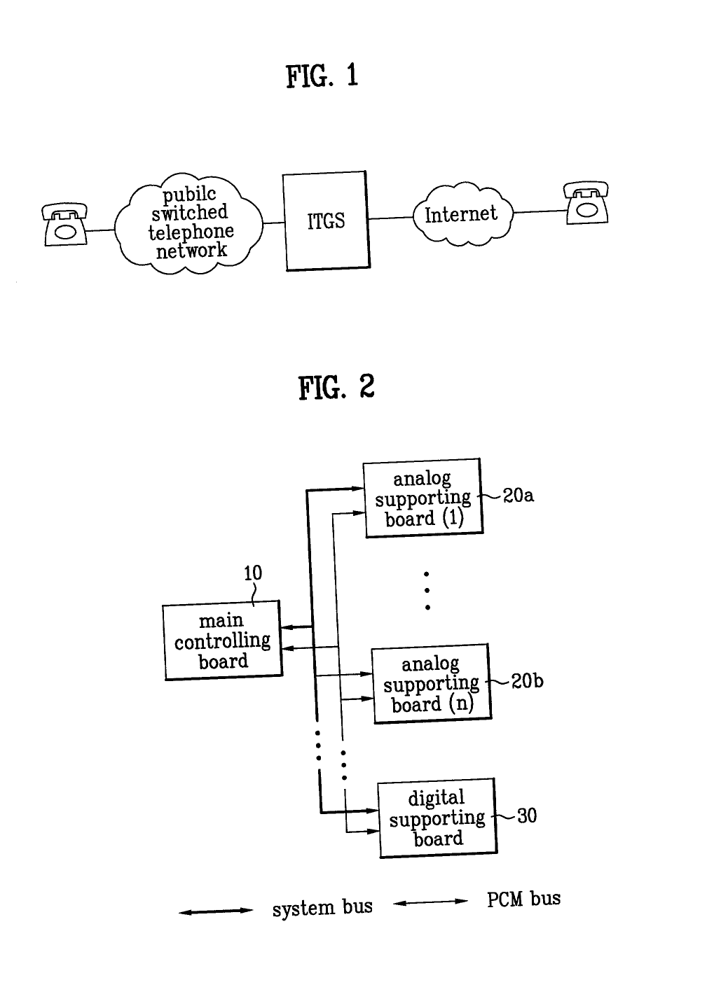

### DETAILED DESCRIPTION OF THE PREFERRED EMBODIMENTS

Reference will now be made in detail to the preferred embodiments of the present invention, examples of which are illustrated in the accompanying drawings.

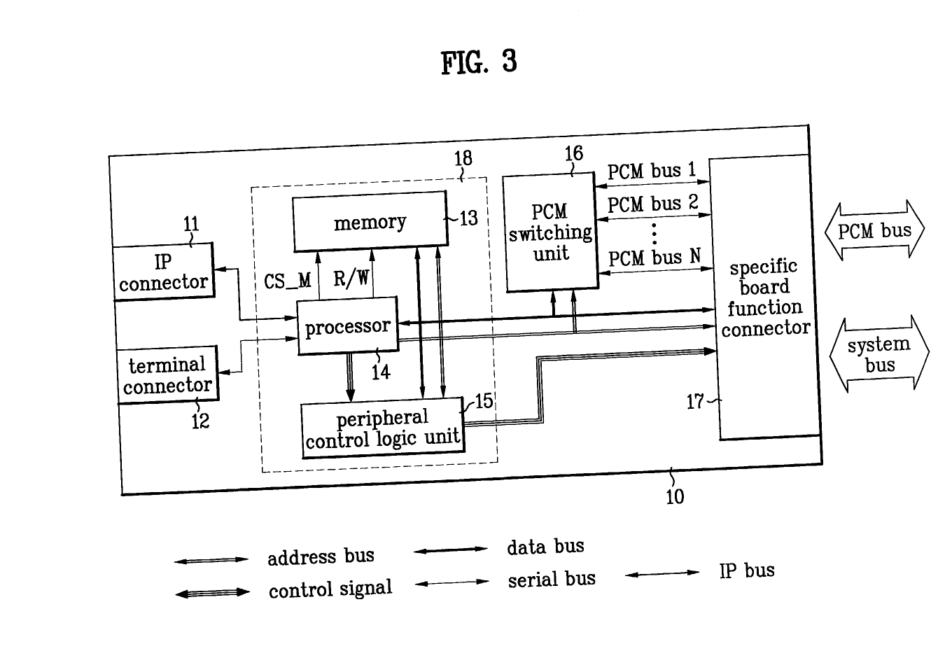

FIG. 2 is a drawing illustrating the Internet telephony gateway system according to a preferred embodiment of the present invention. As shown in FIG. 2, the Internet telephony gateway system comprises a main controlling board 10 equipped with a processor module, which is linked with an external operation terminal by a terminal connector to enable an operator to access a usage software residing or being executed in a processor module for maintaining the status of the main controlling board and each specific function board and, simultaneously, controlling operations of sub modules within each specific function board by using control signals.

In the gateway systems, information such as compressed voice data and destination addresses, which are transmitted from each controlling board, are formed as IP packet data which are transmitted to an external IP network through an IP connector and destination addresses. The gateway system also extracts compressed voice data from the IP packet data received from the IP connector and transmits to each corresponding specific function board through the processor module, and a plurality of specific function boards 20a, 20b, and 30, which compress or restore voice data through an interface with the main controlling board to support physical connection with an external device, such as telephone, facsimile unit or switching center.

Preferably, the specific function board comprises analog support boards 20a and 20b for processing analog signals a digital support board 30 for processing digital signals. The gateway system may be equipped with one or more of the analog and the digital support boards.

Although in the term “board” is being used to described the present invention, the board is only an exemplary implementation of a device performing a described function. The term “board” includes such articles of manufacture that refers to code or logic implemented in hardware logic (e.g., an integrated circuit chip, Field Programmable Gate Array (FPGA), Application Specific Integrated Circuit (ASIC), etc.). Of course, those skilled in the art will recognize that many modifications may be made to this configuration without departing from the scope of the present invention, and that the article of manufacture may comprise any information bearing medium known in the art.

FIG. 3 illustrates a schematic block diagram of the main controlling board 10 according to the present invention. As shown in FIG. 3, the main controlling board 10 includes an IP connector 11, a terminal connector 12, a specific function board connector 17, a processor module 18, and a PCM switching unit 16. According to the preferred embodiment, the processor module 18 comprises a memory unit 13, a processor unit 14, and a peripheral control logic unit 15.

Preferably, the IP connector 11 transmits compressed voice data, which is transmitted from each specific function board through the system bus and which is formed as an IP packet data by the processor module 18, is transmitted to an external IP network. The IP packet data received by the external IP network is transmitted to a processor module 18 to extract the compressed voice data which is then transmitted to the voice compressing/restoring processor of each specific function board to be processed.

Other than the main function of supporting an external IP connection, an operator supports a setting of a physical path, so that an operational software executed in the processor module 18 is connected when an operation and maintenance of an IP network system is desired. The terminal connector 12 provides interface between a processor within the processor module 18 and an operator, which supplies the operational and maintenance functions of an operation system.

In addition, the specific function board connector 17 enables a physical interface of the main controlling board and the specific function board. Preferably, the main controlling board 10 uses a Codec unit requiring a mounting status of a specific function board and a control of the processor module 18 within the specific function board, or a system bus including an address bus needed for the control of each block of a specific function board, such as a frame conversion processor, a data bus and corresponding signals, and a PCM bus needed for the characteristic function block of a specific function board (analog connection and digital connection) and the voice data transmission with the voice compressing/restoring processor.

The processor module 18 is preferably equipped with an operational program, which supports an interface among the IP connector 11, the terminal connector 12 and the specific function board connector 17, thereby supporting a control of the entire system. Such operation program is responsible for processing a call according to a PSTN, storage of operation, and other plurality of protocol processing.

In addition, the processor module 18 provides a status of a specific function board according to the information on an internal structure and formation of a system received through the IP connector 11 or the terminal connector 12 in accordance with the control order of a system operator. The processor module 18 controls each specific function board after having initial operation modes of each specific function board designated through the system bus according to the operator control and enables the initial set value to be changed while the system is operating through the system bus when necessary. The processor module 18 also provides the operator with the operation status received through the system bus.

Furthermore, the processor module 18 preferably uses the PCM bus to transmit the voice data, processed in accordance with the characteristic function (analog connection and digital connection) of each specific function board, to the voice compressing/restoring processor formed within each corresponding board. The processor module 18 transmits data restored by the voice compressing/restoring processor of the corresponding boards to the characteristic function block of each specific function. The PCM switching unit 16 is used to establish the path among the PCM buses.

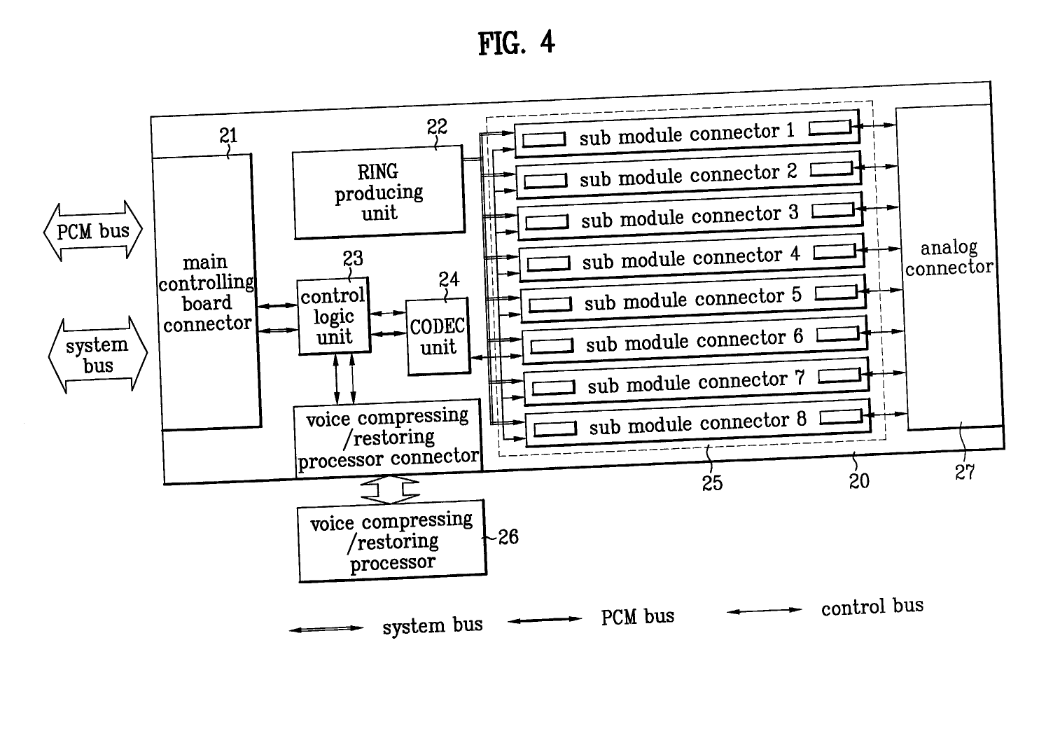

FIG. 4 illustrates the structure of an analog support board 20, which is a specific function board, according to the present invention. As shown in FIG. 4, the analog support board 20 includes a main controlling board connector 21, a control logic unit 23, a voice compressing/restoring processor 26, a ring producing unit 22, a sub module adapter or connector 25, a Codec unit 24, and an analog connector 20. Preferably, the main controlling board connector 21 supports interface with the main controlling board 10 by using the system bus and the PCM bus.

The control logic unit 23 informs the mounting status of each function to an operator connected through an IP connector or a terminal connector, receives control data from the processor module 18 through the system bus and then controls the function modules of each analog supporting board or maintains the status information, and finally, by being equipped with a matching function of PCM, supports the interface between the PCM switching unit 16 of the main controlling board and the voice compressing/restoring processor 26.

The voice compressing/restoring processor 26 either compresses a voice data received from a PCM bus linked to the PCM switching unit 16 of the main controlling board 10 by a method according to the operation status from an operational program residing in the processor module and transmits the compressed data to the main controlling board 10 through the system bus or restores a compressed voice data received from the main controlling board 10 through the system bus by a method according to the operation status from the operational program and transmits the restored data to the controlled PCM switching unit of the processor module 18 through the PCM bus.

The ring producing unit 22 produces call signals when required, when FXS module and E&M module are mounted as sub modules through the sub module connector within the analog support board 20. In addition, the sub module connector 25 mounts the sub modules, such as FXS, FXO, and E&M, and transmits each mounting status to the control logic unit 23 to process according to the demand of the system operator.

The Codec unit 24 either converts an A-law or μ-law signal received from the sub module connector 25 to PCM data or converts PCM data received from the PCM switching unit of the main controlling board through the PCM bus to an A-law or μ-law signal.

The analog connector 27 supports the physical connection with a telephone, facsimile unit, or other compatible device in accordance with the supporting status of the sub module. The analog connector 27 is connected to the sub module connector 25.

Preferably, sub modules such as FXS, FXO, and E&M, which are analog voice interfaces mounted in the sub module connector 25, preferably includes eight (8) ports, each part having detachable functions.

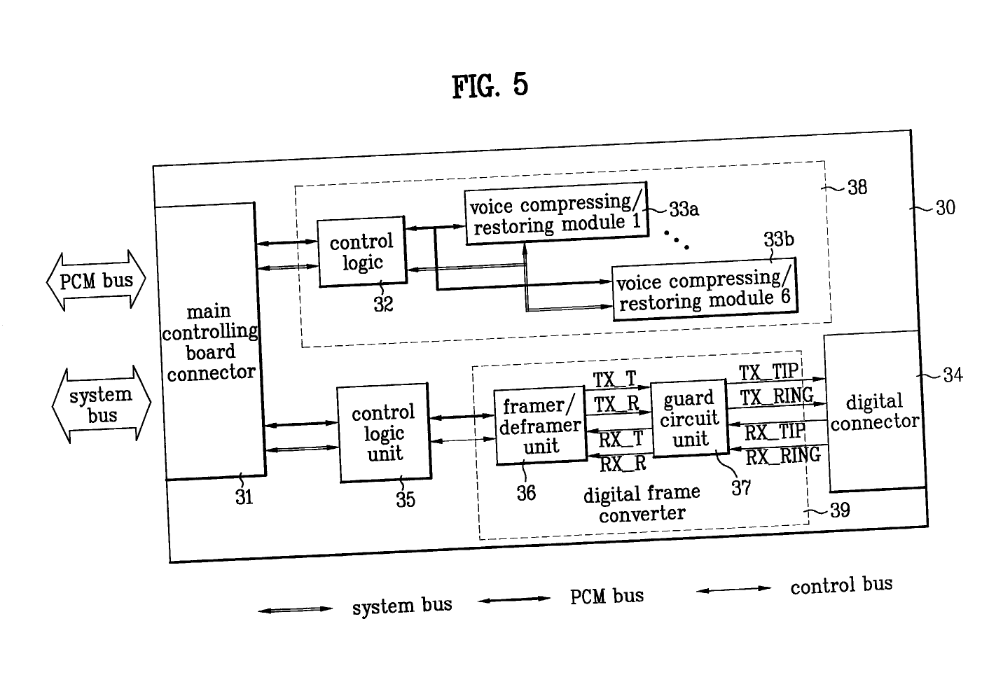

FIG. 5 illustrates a digital support board 30, which is a specific function board, according to the present invention. As shown in FIG. 5, the digital support board comprises a main controlling board connector 31, a control logic unit 35, a voice compressing/restoring processor 38, a digital connector 34, and a digital frame converter 39.

More specifically, the main controlling board connector 31 supports the interface with the main controlling board 10 by using the system bus and the PCM bus. The control logic unit 35 either informs about the mounting status of the board to an operator connected through an IP connector or a terminal connector of the processor module in the main controlling board, or with a control data received from the processor module 18 through the system bus, the control logic unit 35 produces a signal for initializing the digital frame converter 39 or status control, and forms an interface matching logic between the PCM bus of the digital frame converter 39 and the PCM bus linked to the PCM switching unit 16 of the main controlling board 10 shown in FIG. 3.

The voice compressing/restoring processor 38 either compresses a voice data received from the PCM bus linked to the PCM switching board 16 of the main controlling board 10 by a method defined by the operation status of an operational program residing in the processor module 18 and transmits the compressed data to the main controlling board 10 through the system bus. The voice compressing/restoring processor 38 restores a compressed voice data received from the main controlling board 10 through the system bus by a method defined by the operation status of an operational program and transmits the restored data to the controlled PCM switching unit 16 of the processor module through the PCM bus.

The voice compressing/restoring processor 38 includes a control logic 32, equipped with a PCM matching function of the voice compressing/restoring processor 38, supports the PCM bus matching between the PCM switching unit of the main controlling board 10 and the voice compressing/restoring processor 38, and supports the control among the voice compressing/restoring processors 38 through the system bus, and a plurality of voice compressing/restoring modules 33a and 33b.

The digital connector 34 supports the physical connection with the digital trunk of the switching center.

The digital frame converter 39 converts a E1/T1 signal received by the digital connector 34 to a PCM data and transmits the data to the PCM switching unit of the main controlling board 10 through the PCM bus. The digital frame converter 39 also converts a PCM data received by the PCM switching unit to a E1/T1 frame and informs the connection status of E1/T1 according to the control of an operational program residing in the processor module in order to enable the converted data to be transmitted externally through the digital connector 34.

The digital frame converter 39 includes a framer/de-framer unit 36 and a guard circuit unit 37.

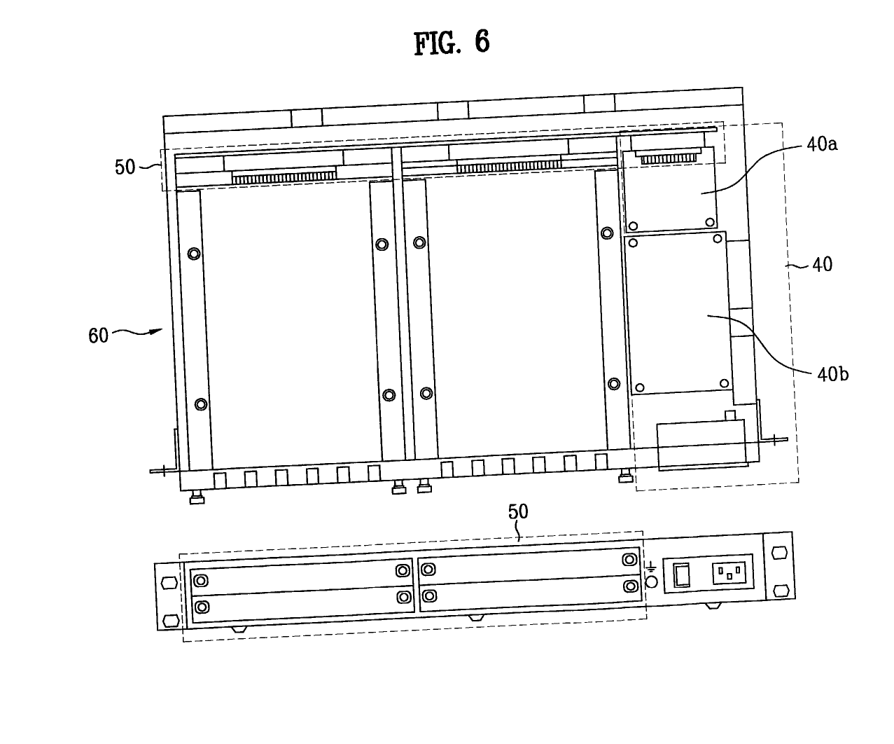

FIG. 6 illustrates a preferred embodiment of the case structure for supporting the Internet telephony gateway system according to the present invention. As shown in FIG. 6, the case 60 includes a power processor 40, which is divided into an AC/DC unit 40b and a DC/DC unit 40a, and a back board 50, which supports the physical interface between the main controlling board 10 and the specific function boards. The case 60 preferably uses four (4) slots to accommodate variety functional boards described above.

The back board 50 is formed so that a position of the main controlling board 10 is designated to a specific slot and the remaining three (3) slots are used for mounting the specific function boards 20a, 20b, and 30 as shown in FIG. 2.

In order support a diverse range of system application, the specific function boards 20a, 20b, and 30 are divided into analog board and digital board. Each specific function board is equipped according to the voice supporting capacity of the specific function boards, with the voice compressing/restoring processors 26 and 38 with a sub module of different forms.

In addition, the analog support board forms each function, such as FXS, FXO, and E&M, which are designed to satisfy the demands of an analog operator into a one (1)-channel sub module unit in order to form the sub module connector with a detachable function by a one (1)-channel unit. Thus, each function is analyzed so that each function can hold one (1) to eight (8) channels, either independently or in combination.

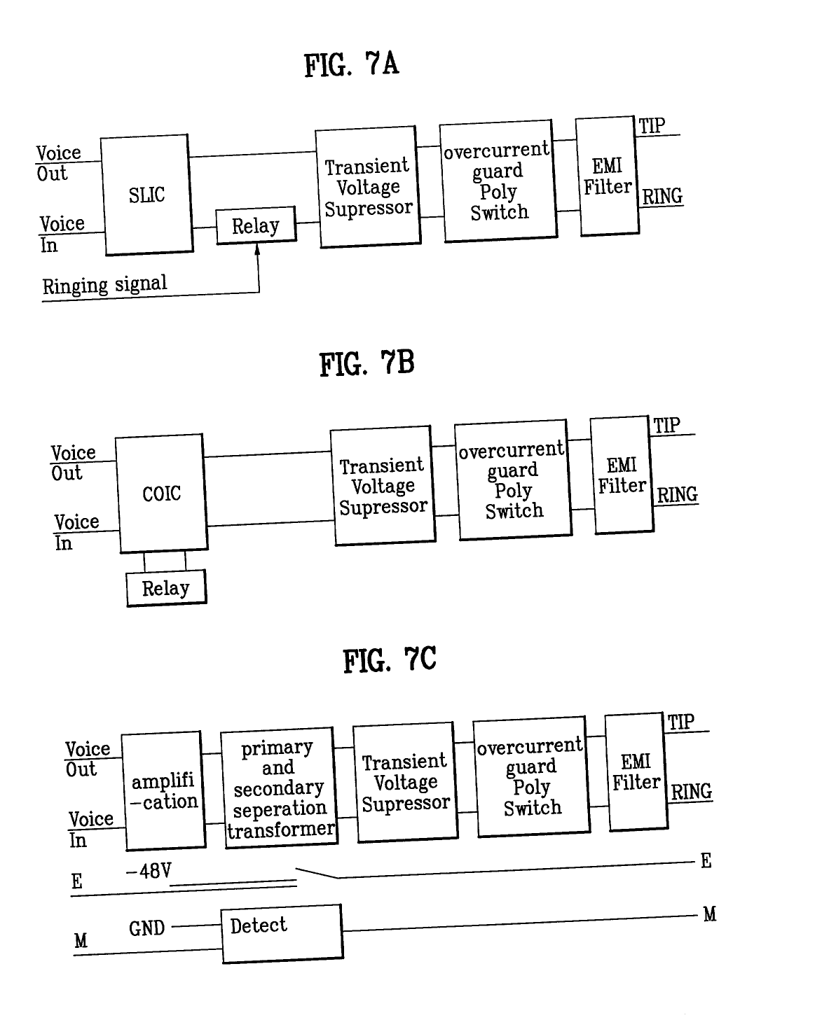

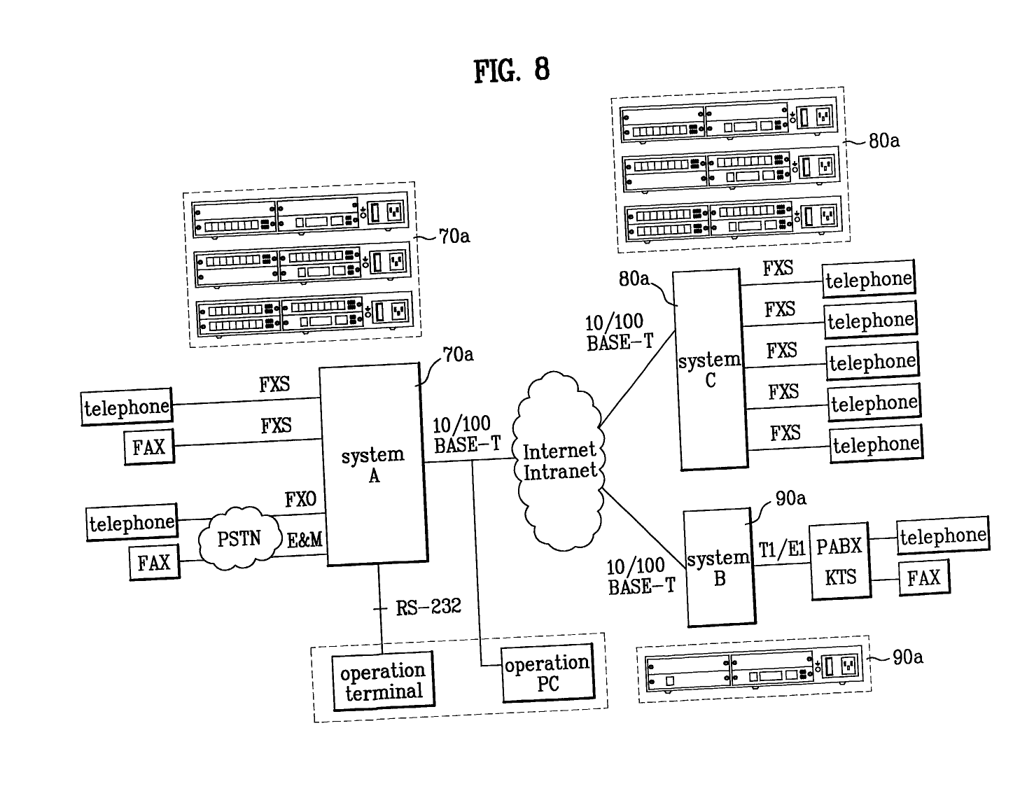

Portions that should be preferably divided according to each functional characteristics must be formed as a module as illustrated in FIGS. 7A, 7B, and 7C. In order to satisfy the characteristic purpose of different network application, the main controlling board 10 (shown in FIG. 3) is equipped with an IP connector 11. A connector for connecting to the PSTN is provided in each specific function boards 20a, 20b, and 30.

The detailed description of the operation of the Internet telephony gateway system for an analog support type and a digital support type is provided below.

FIG. 8 illustrates a system mounting type gateway system and a service network for an analog protocol. As shown in FIG. 8, when an operator desires an analog connection by using the IP network, the structures of system ‘A’ 70a, system ‘B’ 90a, and system ‘C’ 80a are provided in a case 60 with a power processor 40 and a back board 50. In other words, the structure includes a case 60 mounted with an MPU as a main controlling board and an AVU as a specific function board with analog support.

As shown in FIG. 4, the analog support board is equipped with a main controlling board connector 21, a control logic unit 23, a voice compressing/restoring processor 26, a ring producing unit 22, a Codec unit 24, a sub module connector 25, and an analog connector 20.

In addition, the sub module connector includes an FXS module which performs a function to connect to a POTS and a FAX, thereby providing power to an internal line subscriber, transmitting ringing, sensing a dial of a telephone, and is equipped with a hybrid circuit for telephone connection and an A/D and D/A conversion circuit. The sub module connector also includes an FXO module which has a circuit that extracts ringing from an analog trunk with connecting function, a circuit controlling a loop to transmit a dial to the side of an analog trunk, a hybrid circuit for telephone connection, and an A/D and D/A converting circuit. The sub module connector also includes an E&M module which has a connecting function in an E&M trunk of a switch center enabling voice switching through Tip/Ring and signal switching through E/M. Each module is formed with a one (1)-channel unit module enabling internal mounting.

In an AVU, as an analog supporting board, the FXS module, the FXO module, and the E&M module may be formed into preferably one (1) to eight (8) channels, either independently or in combination. The preferred structure of a case according to the present invention may accommodate three (3) AVSs increasing the total channels to 24.

Therefore, the signal received from the analog connector 20 is transmitted to a sub module in accordance with the corresponding terminal or characteristic of support of the connector. Then, the signal is converted to an A-law or a μ-law and transmitted to the Codec unit 24. From the Codec unit 24, the signal is converted to a PCM data, which then passes through the main controlling board connector 21 and the specific function connector 17 of the MPU, which is the main controlling board 10, to be transmitted to the PCM switching unit 16 through the PCM bus.

Then, the PCM switching unit 16 transmits the data, which is received through the PCM bus to the voice compressing/restoring processor 26 mounted inside the AVU board. This is a predetermined switching path, through the PCM data bus.

The voice compressing/restoring processor 26 mounted on the AVU board is controlled by the processor module 18 on the MPU. The voice is compressed by inputting the data received using the PCM bus through the main controlling board connector 21. Such compressed voice data passes through the main controlling board connector 21 within the AVU and the specific function connector 17 within the MPU, and then is transmitted to the processor module 18 through the system bus.

The processor module 18 converts the information, such as the compressed voice data and final destination addresses, into the IP packet data. The converted IP packet data passes through the IP connector 11 installed within the MPU board, and then is transmitted to corresponding equipment by IP network.

The data received from the IP network passes through the IP connector 11 within the MPU, and then is transmitted to the processor module 18. In the processor module 18, the compressed voice data and destination addresses are extracted from the received IP packet data.

To set a path in which the compressed voice data is restored and transmitted according to the extracted destination addresses, the PCM switching unit 16 is used. Then, the compressed voice data passes through the specific function connector of the MPU and the main controlling board connector of the AVU, and then is output to the voice compressing/restoring processor by the system bus.

In the present invention, the output data is transmitted to the voice compressing/restoring processor 38. The voice data restored by a restoring processor passes through the main controlling board connector of the AVU and the specific function connector of the MPU, and then is transmitted to the PCM switching unit 16 by the PCM bus. After that, the voice data is transmitted to the Codec unit through the PCM bus by control of the operating software analyzing the destination addresses, so that the data is converted to either A-law or μ-law.

Subsequently, the voice data passes through a corresponding sub module 25, and then is transmitted to a terminal connected with the analog connector 20 within the AVU board.

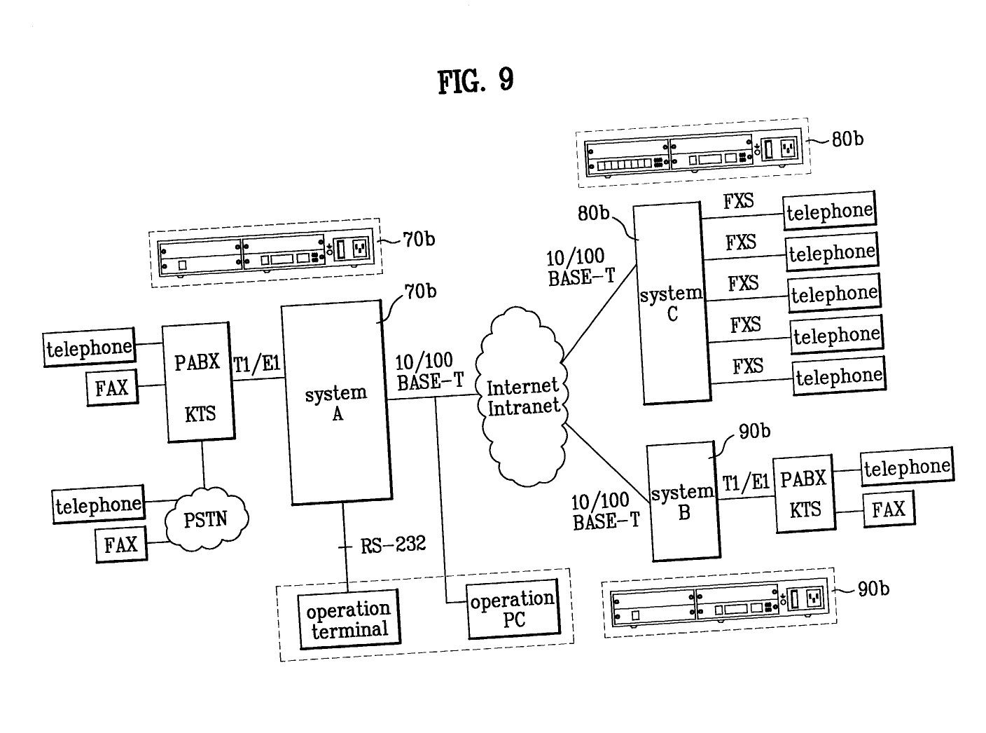

The digital supporting type will be described in detail with reference to a system mounting type and service network construction view shown in FIG. 9.

In FIG. 9, if an operator wants a digital connection using the IP network, a system includes a case 60 having the power supply processor 40 and the back board 50. In the case 60, the MPU and the DVU are installed or connected. The MPU is the main controlling board, and the DVU is the specific function board to support digital signal processing.

The digital supporting board 30 (shown in FIG. 5) includes the main controlling board connector 31, the control logic unit 35, the voice compressing/restoring processor 38, the digital frame converter 39 and the digital connector 34.

In the described embodiment, the T1/E1 frame signal received from the switching center by the digital connector 34 is transmitted to the frame converter 39. The digital frame converter 39 converts the received T1/E1 frame signal to the PCM signal. Then, the PCM signal passes through the main controlling board connector 31 and the specific function connector 17 of the MPU, which is the main controlling board 10, and then the signal is transmitted to the PCM switching unit 16 through the PCM bus.

According to a digital signal method to support a connection with the switching center that is included in the operating software residing in the processor module, the T1/E1 frame is analyzed to recognize a valid voice signal region. Therefore, the recognized voice signal region is used as data for setting a switching path on the PCM bus.

In the switching unit 16, the data received by the PCM bus connected with the digital frame converter is transmitted by the PCM bus connected with the voice compressing/restoring processor 38, which is the set switching path in response to the operating program.

The voice compressing/restoring processor 38 on the DVU board is controlled with the operating software residing in the processor module 18 within the MPU. Then, the voice is compressed by inputting the data received by the PCM bus through the main controlling board connector 31. The compressed voice data passes through the main controlling board connector 31 of the DVU and the specific function connector 17 on the MPU, and then is transmitted to the processor module 18 through the system bus.

The processor module 18 converts information such as the compressed voice data transmitted and final destination addresses to IP packet data. The converted IP packet data passes through the IP connector 11 within the MPU board, and is transmitted to corresponding equipment by IP network.

The data received by the IP network passes through the IP connector 11, and then is transmitted to the processor module 18. In the processor module 18, the compressed voice data and the destination addresses are extracted from the received IP packet data.

The data received by the IP network passes through the IP connector 11 and is transmitted to the processor module 18. In the processor module 18, the compressed voice data and destination addresses are extracted from the received IP packet data.

Subsequently, to set a path in which the compressed voice data is restored and transmitted according to the extracted destination addresses, the PCM switching unit 16 is controlled. Then, the compressed voice data passes through the specific function connector of the MPU and the main controlling board connector of the DVU, and then is output to the voice compressing/restoring processor 38 by the system bus.

The output data is transmitted to the voice compressing/restoring processor 38. The voice data restored by the restoring process passes through the main controlling board connector of the DVU and the specific function connector of the MPU, and then is transmitted to the PCM switching unit 16 by the PCM bus. After that, the voice data is transmitted to the digital frame converter through the PCM bus connected with the digital frame converter 39 by control of the operating software analyzing the destination addresses.

In the digital frame converter 39, the output data is converted to the T1/E1 frame, and then passes through the digital connector 34. The data is then converted to an electrical signal and is transmitted to a digital trunk of the switching center connected with an external connector.

Referring to FIG. 8, in the application of the present invention by the IP network, in the system ‘A’ 70a which supports the analog protocol form, it is possible to provide service by the IP network not only to the system ‘B’ 90a but also to the system ‘C’ 80a which supports the digital protocol.

Also, referring to FIG. 9, the system ‘A’ 70b that supports the digital protocol can be linked with not only the system ‘C’ 80b but also the system ‘B’ that supports the analog protocol.

As described above, an Internet telephony gateway system has the following advantages. First, as an analyzing function of the system, the external connector is divided into the IP network and the public telephone connector. The IP network is formed as a function module of the main controlling board to control and maintain the system. The public telephone connector supports analog/digital forms according to the related supporting types, in which each voice compressing/restoring module is respectively formed as a specific function board module formed as a sub module to facilitate individual testing and maintenance of the system.

For example, in the analog supporting type, the sub module can be expanded by a one (1)-channel unit such as FXS, FXO, and E&M, so that a completed system can be used for examining the functions. It is also possible to change the system by function unit, and the analog type can either be changed to the digital protocol or used in both analog and digital protocols.

Subsequently, the public telephone connector is divided into the analog and digital protocols, and then formed as specific function boards. The analog and digital protocols are formed as modules, by mounting the voice compressing/restoring processor within the specific function module.

Moreover, in the analog supporting protocol, a function support of a board unit is limited in eight (8) channels. In the respective sub modules, functions are formed as main board and the respective function unit such as FXS, FXO, and E&M are formed as module by a one (1)-channel unit. Furthermore, it is easy to construct a type according to a demand of an operator.

For example, two (2) types such as the analog and digital protocols are supported by using a single system, so that it is easy to construct the system according to an operation type of the operator by changing or additionally purchasing the specific function board.

Finally, it is easy to increase system capacity by installing extra modules as needed. In other words, in the analog supporting type, three (3) AVU boards can be mounted within the system, and in the respective AVUs channels are supported from one (1) channel to eight (8) channels by function module unit (FXS, FXO, and E&M). Therefore, the system capacity can be increased from one (1) to twenty-four (24) channels.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A gateway system for use with a communication network to communicate between a first communication device and a second communication device, comprising:
a main controlling device that controls the gateway system which links the first and the second communication devices, the main controlling device preparing a packet comprising compressed voice data and transmitting the packet to the communication network or extracting compressed voice data from the packet received from the communication network and transmitting the extracted data to at least one specific function board in response to a signal form of the extracted data; and
at least one specific function device connected to the main controlling device for processing one of analog signal protocol and digital signal protocol, wherein the extracted data is provided to a digital specific function device to communicate with a communication device capable of processing digital data, and the extracted data is provided to an analog specific function device to communicate with a communication device capable of processing analog data.

2. The gateway system of claim 1, wherein the main controlling device includes:
a processor module executing an operational program that supports interface with the specific function device; and
a PCM switching unit establishing paths of PCM buses of the processor module and voice compressing/restoring processors.

3. The gateway system of claim 2, wherein the analog specific function device includes:
a voice compressing/restoring processor for compressing, using a predefined compression algorithm, a voice data received from the PCM switching unit and transmitting the compressed data to the main controlling device, and for restoring compressed voice data received from the main controlling device and transmitting the restored voice data to a corresponding PCM switching unit;
a control logic unit that provides information pertaining to a mounting status of specific function device and interfacing with the PCM switching unit and the voice compressing/restoring processor;
a sub module adapter for receiving at least one sub module and for transmitting connection status to the control logic unit;
a ring producing unit connected to the sub module adapter for producing a call signal to the sub module adapter; and
a codec unit for converting a predetermined protocol signal received from the sub module adapter to PCM data or converting the PCM data received from the PCM switching unit of the main controlling device to the predetermined protocol.

4. The gateway system of claim 3, wherein the predetermined protocol signal is one of an A-law or μ-law signal.

5. The gateway system of claim 3, further including an analog connector supporting a physical connection with a telephone, facsimile unit, or other compatible device in accordance with the sub module connected to the sub module adapter capable of handling such devices.

6. The gateway system of claim 3, wherein the analog specific function device communicated with the main controlling device through a PCM bus and a system bus.

7. The gateway system of claim 2, wherein the digital specific function device includes:
a voice compressing/restoring processor for compressing, using a predefined compression algorithm, a voice data received from the PCM switching unit and transmitting the compressed data to the main controlling device, and for restoring compressed voice data received from the main controlling device and transmitting the restored voice data to a corresponding PCM switching unit;
a digital frame converter for converting a first digital type signal to a PCM data and converting a PCM data received by the PCM switching unit to a first digital type signal; and
a control logic unit that provides status of the digital specific function device.

8. The gateway system of claim 7, wherein the first digital type signal is an E1/T1 signal.

9. The gateway system of claim 7, wherein the control logic unit further producing a signal for initializing the digital frame converter and forming an interface matching logic between a PCM bus linked to the PCM switching unit of the main controlling device and the digital frame converter.

10. The gateway system of claim 7, further including a main controlling device connector supporting an interface with the main controlling device by using a system bus and a PCM bus.

11. The gateway system of claim 7, further including a digital connector supporting a physical connection with a digital trunk of a switching center.

12. The gateway system of claim 7, wherein the voice compressing/restoring processor includes:
at least one voice compressing/restoring modules compressing and restoring voice data; and
a control logic device for communicating between the PCM switching unit of the main controlling device and the at least one voice compressing/restoring processors and controlling the at least one voice compressing/restoring module.

13. The gateway system of claim 1, wherein the main controlling device connects to an IP network and the specific function device connects to a public switched telephone network to transmit and receive voice data.

14. The gateway system of claim 1, further including
a power processor divided into an AC/DC unit and a DC/DC unit; and
a back board for supporting a communication interface between the main controlling device and the specific function device using a plurality of adapters to enable each board to be mounted inside the system.

15. The gateway system of claim 14, wherein the back board is formed so that a position of the main controlling device is designated to a specific adapter and that the remaining adapters are randomly mounted with the specific function devices.

16. A gateway system for use with a communication network to communicate between a first communication device and a second communication device, comprising:
a main controlling device that controls the gateway system which links the first and the second communication devices, the main controlling device preparing a packet comprising compressed voice data and transmitting the packet to the communication network or extracting compressed voice data from the packet received from the communication network and transmitting the extracted data to at least one specific function board in response to a signal form of the extracted data;
an analog specific function device connected to the main controlling device for processing an analog signal protocol, wherein the extracted data is provided to the analog specific function device to communicate with a communication device capable of processing analog data; and
a digital specific function device connected to the main controlling device for processing a digital signal protocol, wherein the extracted data is provided to the digital specific function device to communicate with a communication device capable of processing digital data.

17. The gateway system of claim 16, wherein the main controlling device includes:
a processor module executing an operational program that supports interface with the specific function device; and
a PCM switching unit establishing paths of PCM buses of the processor module and voice compressing/restoring processors.

18. The gateway system of claim 17, wherein the analog specific function device includes:
a voice compressing/restoring processor for compressing, using a predefined compression algorithm, a voice data received from the PCM switching unit and transmitting the compressed data to the main controlling device, and for restoring compressed voice data received from the main controlling device and transmitting the restored voice data to a corresponding PCM switching unit;
a control logic unit that provides information pertaining to a mounting status of specific function device and interfacing with the PCM switching unit and the voice compressing/restoring processor;
a sub module adapter for receiving at least one sub module and for transmitting connection status to the control logic unit;
a ring producing unit connected to the sub module adapter for producing a call signal to the sub module adapter; and
a codec unit for converting a predetermined protocol signal received from the sub module adapter to PCM data or converting the PCM data received from the PCM switching unit of the main controlling device to the predetermined protocol.

19. The gateway system of claim 16, wherein the digital specific function device includes:
a voice compressing/restoring processor for compressing, using a predefined compression algorithm, a voice data received from the PCM switching unit and transmitting the compressed data to the main controlling device, and for restoring compressed voice data received from the main controlling device and transmitting the restored voice data to a corresponding PCM switching unit;
a digital frame converter for converting a first digital type signal to a PCM data and converting a PCM data received by the PCM switching unit to a first digital type signal; and
a control logic unit that provides status of the digital specific function device.

20. The gateway system of claim 19, wherein the control logic unit further producing a signal for initializing the digital frame converter and forming an interface matching logic between a PCM bus linked to the PCM switching unit of the main controlling device and the digital frame converter.

21. The gateway system of claim 19, further including a main controlling board connector supporting an interface with the main controlling device by using a system bus and a PCM bus.
